(19) United States
(12) Patent Application Publication
(10) Pub. No.: US 2005/0127558 A1
(43) Pub. Date: Jun. 16, 2005

(54) Process for preparation of polypropylene moulding compound having high impact and flexural strength

(75) Inventors: Radhakrishnan Subramaniam, Maharashtra (IN); Pradip Sonwane, Maharashtra (IN)

Correspondence Address: NIXON & VANDERHYE, PC, 1100 N GLEBE ROAD, 8TH FLOOR, ARLINGTON, VA, 22201-4714, US

(73) Assignee: Council of Scientific and Industrial Research, New Delhi (IN)

(21) Appl. No.: 10/731,439

(22) Filed: Dec. 10, 2003

(51) Int. Cl. B29C 47/00; B29C 47/38

(52) U.S. Cl. 264/211; 264/211.23

(57) ABSTRACT

The present invention relates to a process for the preparation of polypropylene moulding compound which gives high impact and flexural strength to the moulded component which are extensively used in automobile industry.

### FIELD OF THE INVENTION

The present invention relates to a process for the preparation of polypropylene moulding compound having high impact and flexural strength. More particularly, it provides a process by which polypropylene can be modified with additives which impart high impact and flexural strength.

### BACKGROUND OF THE INVENTION

There is a large demand for commodity polymers such as polypropylene having enhanced mechanical properties such as tensile, flexural and impact strength. This is especially true for their applications in automobile components. Impact strength becomes important for such applications. The impact strength of polypropylene is usually increased by incorporation of rubbery component either externally or internally by co-polymerization. However, this invariably affects the tensile and flexural strength of polypropylene due to differences in crystallinity and weak bonds at the interface. The tensile and flexural strengths are known to decrease considerably with incorporation of rubbery component (Ref: Handbook of Polyolefins, Marcel Dekker, New York, 1993 Chapter 10). The use of modified additives is disclosed in copending Indian Patent Application 2626/DEL/96 for improvement of impact strength. However, that process does not consider changes in the flexural strength and is not compatible with a large number of other additives. These drawbacks have to be overcome for improved performance of polypropylene in automobile components such as bumpers and dashboards which require both high impact and flexural strength. There is no prior art for increasing both impact and flexural strength of polypropylene moulding compound.

### OBJECTS OF THE INVENTION

The main object of the present invention therefore is to provide a process for preparation of polypropylene moulding compound having high impact strength as well as high flexural strength.

### SUMMARY OF THE INVENTION

Accordingly, the present invention provides a process for the preparation of polypropylene moulding compound having high impact strength above 30 Kg cm/cm and flexural strength above 330 Kg/cm², which comprises blending polypropylene with another polymer in the range of 20 to 50 wt %, adding a compatibilizer agent and optionally a colouring agent, melt kneading the mixture in presence of a low molecular weight co-polymer, melt extruding the same in a twin screw melt extruder at a temperature in the range of 120 to 180° C. to give a polypropylene moulding compound having high impact and flexural strength.

In one embodiment of the invention, the polypropylene used has isotacticity index in the range of 95 to 98.

In another embodiment, the polymer used for blending is a random co-polymer of ethylene or propylene with butadiene in the ratio of 2:1.

In another embodiment, the ratio of the polypropylene to the co-polymer is in the range of 2:1 to 5:1.

In another embodiment, the compatibilizer is chosen from a branched polymer containing ethylene and octene units having ethylene to octene ratio of 0.1% to 1%.

In yet another embodiment the concentration of the compatibilizer agent is in the range of 10% to 50% of the total polypropylene compound.

In another embodiment the co-polymer used for melt kneading contains butyl, hexyl or octyl units modified with carboxylic acid, maleic acid and ethylene monomer having minimum melt flow index of 5 gm/10 min.

In still another embodiment of the present invention the temperature used for melt kneading is in the range of 120° C. to 180° C. preferably 160° C.

In another embodiment the melt extrusion is carried out at rate of 10 Kg/hr to 36 Kg/hr at the melt temperature in the range of 180° C. to 220° C.

In a feature of the present invention, the colouring agents may be used together with the compound causing no adverse effect on the properties of the moulded component.

### DETAILED DESCRIPTION OF THE INVENTION

The present invention provides a process for the preparation of polypropylene moulding compound having high impact strength above 30 Kg cm/cm and flexural strength above 330 Kg/cm². The process of the invention comprises blending polypropylene with another polymer in the range of 20 to 50 wt % using a compatibilizer agent. Optionally, coloring agents may be used without detracting the properties of the final polymer. The mixture obtained is melt kneaded in the presence of a low molecular weight co-polymer and then melt extruded in a twin screw melt extruder at a temperature in the range of 120 to 180° C. to give a polypropylene moulding compound having high impact and flexural strength.

Preferably, the polypropylene used has isotacticity index in the range of 95 to 98. The polymer used for blending is a random co-polymer of ethylene or propylene with butadiene in the ratio of 2:1. The ratio of the polypropylene to co-polymer is in the range of 2:1 to 5:1.

The compatibilizer is chosen from a branched polymer containing ethylene and octene units having ethylene to octene ratio of 0.1% to 1%. The concentration of the compatibilizer agent is in the range of 10% to 50% of the total polypropylene compound.

The co-polymer used for melt kneading contains butyl, hexyl or octyl units modified with carboxylic acid, maleic acid and ethylene monomer having minimum melt flow index of 5 gm/10 min.

The temperature used for melt kneading is in the range of 120° C. to 180° C., preferably 160° C. and the melt extrusion is carried out at rate of 10 Kg/hr to 36 Kg/hr at the melt temperature in the range of 180° C. to 220° C.

The process of the present invention is described hereinbelow with examples, which are illustrative and should not be construed to limit the scope of the invention in any manner.

### EXAMPLE—1

Polypropylene (1 Kg) having isotactic index of 96, melt flow index of 10 was mixed with 4.6 Kg of random co-polymer containing ethylene and propylene in the ratio of 1:10, 0.4 Kg of compatibilizer having ethylene and octene units in the ratio of 100:1, 0.28 Kg maleic anhydride treated polpropylene, melt kneaded in sigma blade mixer at 160° C. for 20 min and melt extruded at 210° C. then quenched in water and chopped into small pellets to give polypropylene moulding compound. This compound was then injection moulded by conventional machine at 190° C. to form test pieces. The mechanical properties of the test pieces are indicated in Table—1.

### EXAMPLE—2

Polypropylene (1 Kg) having isotactic index of 96, melt flow index of 10 was mixed with 4.6 Kg of random co-polymer containing ethylene and propylene in the ratio of 1:10, 0.4 Kg of compatibilizer having ethylene and octene units in the ratio of 100:1, 0.28 Kg polymer containing acrylate and ethylene units in the ratio of 1:10, melt kneaded in sigma blade mixer at 160° C. for 20 min and melt extruded at 210° C. then quenched in water and chopped into small pellets to give polypropylene moulding compound. This compound was then injection moulded by conventional machine at 190° C. to form test pieces. The mechanical properties of the test pieces are indicated in Table—1.

### EXAMPLE—3

Polypropylene (1 Kg) having isotactic index of 96, melt flow index of 10 was mixed with 4.6 Kg of random co-polymer containing ethylene and propylene in the ratio of 1:10, 0.62 Kg of compatibilizer having ethylene and octene units in the ratio of 100:1, 0.28 Kg polymer containing maleic acid treated polypropylene, 0.08 Kg of linear low density polyethylene, melt kneaded in sigma blade mixer at 170° C. for 20 min and melt extruded at 210° C. then quenched in water and chopped into small pellets to give polypropylene moulding compound. This compound was then injection moulded by conventional machine at 190° C. to form test pieces. Mechanical properties of the test pieces are indicated in Table—1.

TABLE 1
Comparison of mechanical properties of polypropylene
moulding compound

| Polypropylene | | | | Unmodified |
|---|---|---|---|---|
| Moulded sample | Example 1 | Example 2 | Example 3 | Polypropylene |
| Izod Impact | 37 | 30 | 45 | 7.0 |
| Strength | | | | |
| (Kg · cm/cm) | | | | |
| Elongation at | 140 | 109 | 200 | 46 |
| Break (%) | | | | |
| Melt Flow Index | 5.4 | 5.5 | 6.6 | 8 |
| (230° C./2.16 Kg) | | | | |
| Tensile Strength | 257 | 262 | 255 | 300 |
| (Kg/cm²) | | | | |
| Flexural Strength | 338 | 350 | 342 | 265 |
| (Kg/cm²) | | | | |
| Flexural Modulus | 18119 | 19078 | 18050 | 8534 |
| (Kg/cm²) | | | | |

A comparison of the values of impact strength and flexural strength/modulus given in the above Table—1 that the polypropylene moulding compound prepared by the process described in the present invention has much better properties than the original polymer.

The main advantage of the present invention is that it provides a simple method of preparation of polypropylene moulding compound which gives much higher impact strength as well as flexural strength with very little loss of tensile strength.

1. A process for the preparation of polypropylene moulding compound having high impact strength above 30 Kg cm/cm and flexural strength above 330 Kg/cm², which comprises blending polypropylene with another polymer in the range of 20 to 50 wt %, adding a compatibilizer, melt kneading the mixture in presence of a low molecular weight co-polymer, melt extruding the same in a twin screw melt extruder at a temperature in the range of 120 to 180° C. to give a polypropylene moulding compound having high impact and flexural strength.

2. A process as claimed in claim 1 wherein the polypropylene used has isotacticity index in the range of 95 to 98.

3. A process as claimed in claim 1 wherein the polymer used for blending is a random co-polymer of ethylene or propylene with butadiene in the ratio of 2:1.

4. A process as claimed in claim 1 wherein the ratio of the polypropylene to the co-polymer is in the range of 2:1 to 5:1.

5. A process as claimed in claim 1 wherein the compatibilizer is a branched polymer containing ethylene and octene units having ethylene to octene ratio of 0.1% to 1%.

6. A process as claimed in claim 1 wherein the concentration of the compatibilizer is in the range of 10% to 50% of the total polypropylene compound.

7. A process as claimed in claim 1 wherein the co-polymer used for melt kneading contains butyl, hexyl or octyl units modified with carboxylic acid, maleic acid and ethylene monomer having minimum melt flow index of 5 gm/10 min.

8. A process as claimed in claim 1 wherein the temperature used for melt kneading is in the range of 120° C. to 180° C.

9. A process as claimed in claim 1 wherein the temperature for melt kneading is 160° C.

10. A process as claimed in claim 1 wherein the melt extrusion is carried out at rate of 10 Kg/hr to 36 Kg/hr at the melt temperature in the range of 180° C. to 220° C.

11. A process as claimed in claim 1 wherein a coloring agent is included in the mixture prior to melt kneading.
